(19) United States
(12) Patent Application Publication
(10) Pub. No.: US 2015/0148987 A1
(43) Pub. Date: May 28, 2015

(54) Method and control device and detection device for checking for plausibility of wrong-way driving of a motor vehicle

(71) Applicant: Robert Bosch GmbH, Stuttgart (DE)

(72) Inventors: Christian JESCHKE, Beilstein (DE); Christian BRAEUCHLE, Hassmersheim-Hochhausen (DE)

(21) Appl. No.: 14/552,907

(22) Filed: Nov. 25, 2014

(30) Foreign Application Priority Data
Nov. 26, 2013 (DE) 10 2013 224 167.4

(51) Int. Cl. B60W 30/095

(52) U.S. Cl. CPC B60W 30/095
USPC 701/1

(57) ABSTRACT

A method and a control device and detection device are provided for checking for plausibility of wrong-way driving of a motor vehicle having a wireless receiving unit on a directional roadway, at least one signal of a wireless transmitting unit of one other motor vehicle being received, a driving direction of the other motor vehicle being ascertained based on the at least one signal, and the plausibility for wrong-way driving of the motor vehicle or of the other motor vehicle being checked based on the driving direction of the motor vehicle and on the driving direction of the other motor vehicle.

### RELATED APPLICATION INFORMATION

The present application claims priority to and the benefit of German patent application no. 10 2013 224 167.4, which was filed in Germany on Nov. 26, 2013, the disclosure of which is incorporated herein by reference.

### FIELD OF THE INVENTION

The present invention relates to a method and a control device and detection device for checking for plausibility of a wrong-way driving of a motor vehicle.

### BACKGROUND INFORMATION

In the event of an accident, wrong-way drivers, also referred to as ghost drivers, cause deaths, injuries and significant material damage. Wrong-way driving is understood here to mean driving on a directional roadway opposite the prescribed driving direction. A directional roadway is a roadway separated structurally from traffic moving in the oncoming direction. Directional roadways may be found on freeways or expressways, and on developed federal roads. Wrong-way driving may be subdivided into forward driving and driving in reverse, forward driving being initiated as a result of a wrong entry or as a result of a U-turn.

More than half of all occurrences of wrong-way driving start at federal freeway junctions. Specifically, in the case of wrong-way driving on freeways, accidents which occur are accidents frequently involving fatalities due to the high driving speeds and, therefore, the high collision speeds.

The recognition of wrong-way driving with the aid of navigation devices is not always reliably possible, since the information of the navigation device, such as road category and road direction, is provided too late for most cases of wrong-way driving, i.e., the vehicles at that point are already situated in the driving path opposite the driving direction.

### SUMMARY OF THE INVENTION

The method according to the present invention for checking for plausibility of wrong-way driving of a motor vehicle having a wireless receiving unit on a directional roadway includes, in principle, the following steps:

receiving at least one signal of a wireless transmitting unit of one other motor vehicle;

ascertaining a driving direction of the other motor vehicle based on the at least one signal; and

checking for plausibility of wrong-way driving of the motor vehicle or of the other motor vehicle based on the driving direction of the motor vehicle and the driving direction of the other motor vehicle.

The method according to the present invention has the advantage that with components already available such as, for example, cellular telephones, it is possible to simply and reliably check for plausibility of or assess wrong-way driving. The cellular telephones may be carried in the motor vehicle or may be a component of the motor vehicle. It is also possible to utilize other communication solutions installed in the motor vehicle, which are provided, for example, for communication between the motor vehicle and the motor vehicle manufacturer.

For example, Bluetooth or a wireless local area network (WLAN) is employed as protocols of the signals or of the wireless receiving unit and wireless transmitting unit. In this case, each vehicle may represent a router or an infrastructure device of a network, which independently contacts other routers or units of the other motor vehicles in range. An infrastructure mode having a router or access point and clients is possible. Also possible is an ad hoc mode having equally authorized terminal devices. For the method according to the present invention, it is not necessary to establish a network or a connection to a protocol, rather signals are sufficient for preparing a network configuration such as, for example, signals for identifying potential subscribers, for contacting and/or for negotiating transmission parameters or network parameters. From these signals, it is then possible to determine the driving direction of a vehicle, whereas the driving direction of the particular vehicle is known. Thus, recognition of a wrong-way driver is implemented by evaluating signals from, for example, cellular telephones via a WLAN and/or Bluetooth, cellular telephones of correctly driving vehicles being able to identify a wrong-way driver as well as their own correct driving direction, and a cellular telephone of the wrong-way driver being able to identify wrong-way driving based on at least one cellular telephone of a correctly driving vehicle.

It may be provided that the driving direction of the other vehicle is ascertained based on a signal strength of the signal. Thus, based directly on the signal strength, for example, based on a table including signal strengths and distances, it is possible to estimate the distance, and based on two or multiple signals, it is possible to ascertain the moving direction of the other motor vehicle. This allows for a rapid and robust detection of the driving direction.

The driving direction of the other motor vehicle may be ascertained based on a transit time of the signal. Based on the transit time, known, for example, by a time stamp or the like in the signal, it may be directly determined whether the source of the signal, i.e., another motor vehicle, is approaching the motor vehicle, which shortens the transit time, or is moving away, which prolongs the transit time. In this way, too, it is possible to determine the driving direction in a rapid and robust manner.

In addition, the method according to the present invention makes it advantageously possible to detect wrong-way driving of the motor vehicle, if the driving direction of the motor vehicle is opposite the driving directions of at least two other motor vehicles. This may be considered as an additional step of checking for plausibility, which further increases the reliability and safety of the method.

To check for plausibility of wrong-way driving of the motor vehicle, the motor vehicle may have ascertained at least two signals having an opposite driving direction. From the perspective of the motor vehicle driving the wrong way, signals from at least two approaching, correctly driving vehicles are received. This permits a reliable check for plausibility or determination of the wrong-way driving of the particular vehicle, i.e., of the vehicle which receives the signals.

To check for plausibility of wrong-way driving of the motor vehicle, the other motor vehicle may ascertain at least one signal having the same driving direction and one signal having an opposite driving direction. Thus, a correctly driving vehicle may ascertain a vehicle driving the wrong way based only on the signals, even without knowledge of the particular driving direction. Alternatively, the plausibility of wrong-way driving may be checked for using the known particular driving direction, for example, through a position sensor, and using the signal of the vehicle driving the wrong way.

It is also possible to check for plausibility of the driving direction of the motor vehicle using a positioning sensor and/or navigation system of the motor vehicle, and/or to check for plausibility of the driving direction of the other motor vehicle using a positioning sensor and/or navigation system of the other motor vehicle. The additional sensor allows for a further check for plausibility and, therefore, reliability of the method.

It is particularly advantageously provided that the motor vehicle includes a wireless transmitting unit and the other motor vehicle includes a wireless receiving unit, and that signals are transmitted bi-directionally. The wireless units of a vehicle may then be a combined wireless transmitting/receiving unit. This makes a rapid, reciprocal detection and recognition possible, in addition to communication sequences, which permit a more precise ascertaining of driving directions.

During a check for plausibility and/or detection, a warning may be generated. This warning may be transmitted, for example, via vehicle ad hoc networks, such as Car2X links to the respective wrong-way driver, to other road users and/or services, such as traffic reporting stations or traffic control systems. This may also increase traffic safety within a wide radius of the wrong-way driver and/or specifically in the vicinity of the driver.

According to the present invention, a control device and detection device are provided for checking for plausibility of wrong-way driving of a motor vehicle having a wireless receiving unit on a directional roadway, including an arrangement for receiving at least one signal of a wireless transmitting unit of one other motor vehicle, an arrangement for ascertaining a driving direction of the other vehicle, based on the at least one signal, and an arrangement for checking for plausibility of wrong-way driving of the motor vehicle or of the other motor vehicle, based on the driving direction of the motor vehicle and the driving direction of the other motor vehicle. The advantages and modifications described above apply. The arrangement for receiving, such as a wireless transmitting/receiving unit, may be situated within the motor vehicle, either mobile, i.e., removable, or permanently installed. In addition, the wireless transmitting/receiving unit may be connected to the motor vehicle as part of a communication link. The arrangement for ascertaining and/or the arrangement for checking for plausibility may include a controller or a control device or a suitable processing unit.

Advantageous refinements of the present invention are specified herein and described in the description.

Exemplary embodiments of the present invention are explained in greater detail with reference to the drawings and the following description.

### BRIEF DESCRIPTION OF THE DRAWINGS

FIG. 1 schematically shows a representation of a directional roadway on which motor vehicles are driving.

FIG. 2 shows a schematic representation of two motor vehicles, each including a control device and detection device.

FIG. 3 shows a method for checking for plausibility of wrong-way driving of a motor vehicle in the form of a flow chart.

### DETAILED DESCRIPTION

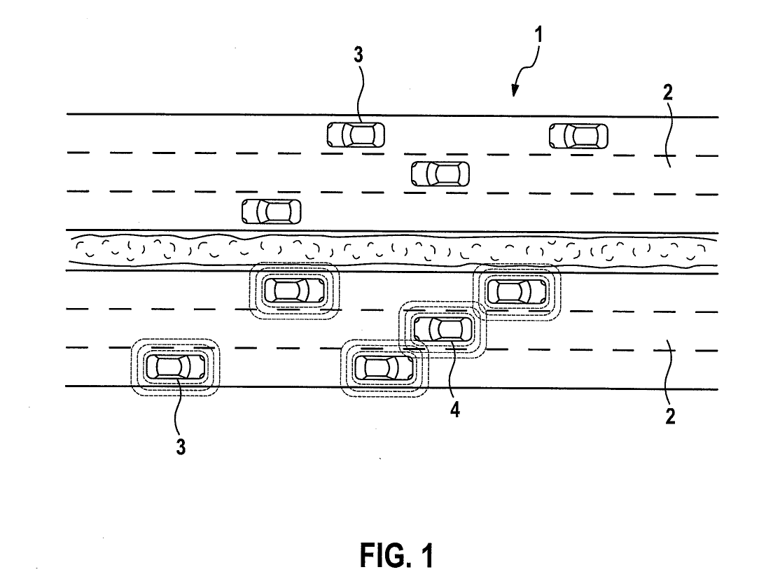

FIG. 1 shows a road or freeway 1 including two directional roadways 2 structurally separated from one another. Multiple motor vehicles 3 are driving or moving in the correct, i.e., prescribed, driving direction. In the lower directional roadway 2 depicted in FIG. 1, motor vehicles 3 are moving from left to right, while motor vehicles 3 in upper directional roadway 2 are moving from right to left. A vehicle driving the wrong way or a wrong-way driver, also referred to colloquially as ghost driver, is moving on lower directional roadway 2 opposite the prescribed driving direction, i.e., from right to left.

For vehicles 3, 4 on the lower directional roadway, detection areas or signal areas are indicated, which surround the vehicles. These areas may have other radiation characteristics such as, in particular, larger spatial coverages.

The term vehicle or motor vehicle is understood to mean all powered modes of transportation such as, for example, passenger vehicles, trucks, busses, motorcycles, etc.

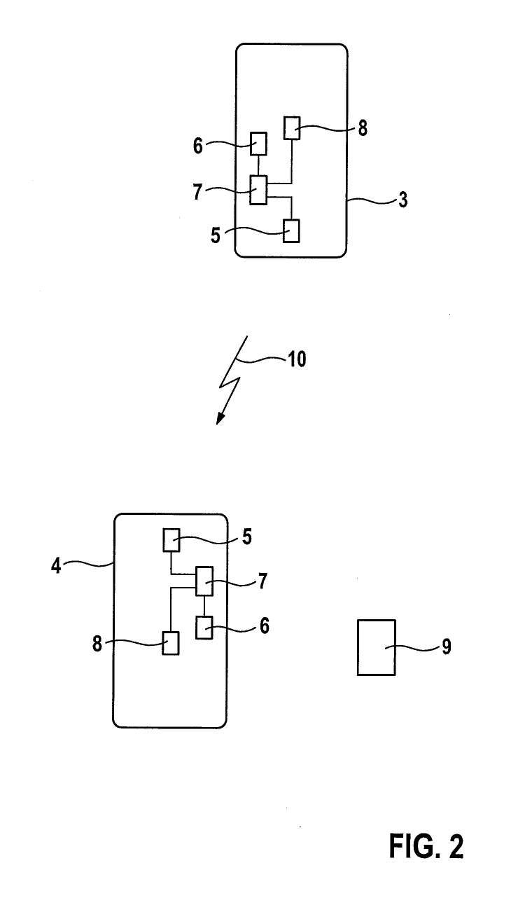

The motor vehicle, respectively, the interaction between two motor vehicles, is described in greater detail below with reference to FIG. 2. Motor vehicle 4 driving the wrong way includes, as does correctly driving motor vehicle 3, a control device and detection device for checking for plausibility of wrong-way driving of a motor vehicle 3 or 4 on a directional roadway 2. The two motor vehicles 3 and 4 in this case are identically configured.

Motor vehicle 3, 4, respectively, the control device and detection device, includes a wireless transmitting/receiving unit 5. This may include multiple communication standards such as, for example, WLAN or Bluetooth. In addition, motor vehicle 4, respectively, the control device and detection device, is equipped with a navigation system 6. Motor vehicle 4, respectively, the control device and detection device, further includes a controller 7. Controller 7 communicates with communication module 5 and navigation device 6; this may be wired or wireless. Controller 7 is also connected to a communication interface 8, which is configured to communicate with an external device 9, such as a central server. This communication interface 8 may also be used, additionally if necessary, as a wireless transmitting/receiving unit for ascertaining a driving direction.

Communication unit 5, navigation module 6, controller 7, and communication interface 8 may—as depicted here—be configured as independent units, or they may be integrated in one or multiple units such as, for example, a cellular telephone. In particular, it is not necessary to implement each component in hardware; individual functions may also be implemented as software routines or programs.

With the aid of communication interface 8, it is possible to provide motor vehicle 4, respectively, the control device and detection device, information, such as map data and/or functionalities, such as an access to programs of external device 9.

Wireless transmitting/receiving unit 5 may, for example, be a cellular telephone or a smartphone. All the functions and calculations may be contained in the cellular telephone, or may be carried out there. It is also possible for the cellular telephone to be linked to controller 7, and the former merely relays signals 10 received from one other motor vehicle 3, so that further processing and calculation is carried out in controller 7.

Described below is the wireless communication between the two vehicles 3 and 4, respectively, between the control devices and detection devices. Wireless transmitting/receiving unit 5 of correctly driving motor vehicle 3 emits a signal 10. In a simplest configuration, motor vehicle 3 may include just one wireless transmitting unit. The combined transmitting and receiving functionality depicted herein may also be assigned to different components.

Signal 10 may be a so-called navigational light signal or beacon signal, in order to draw attention to the existence of motor vehicle 3, respectively, to transmitting/receiving unit 5 of motor vehicle 3. Signal 10 may also be a scanning signal, with which wireless transmitting/receiving unit 5 of motor vehicle 3 prompts corresponding units of other motor vehicles to return a confirmation signal for making subsequent contact.

If motor vehicle 4, respectively, the control device and detection device, receives signal 10 originating from motor vehicle 3, the method for checking for plausibility of wrong-way driving of a motor vehicle described below is then carried out. The method may be carried out either in controller 7 and/or in transmitting/receiving unit 5. In addition, it is possible for the method to be executed at least partially in external device 9.

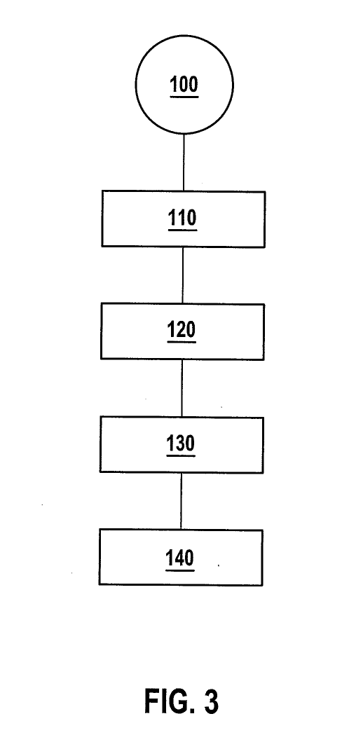

The method for checking for plausibility of wrong-way driving is described below with reference to FIG. 3. In a first step, wireless transmitting/receiving unit 5 of motor vehicle 4 receives a signal 10 of a wireless transmitting/receiving unit 5 of one other motor vehicle 3. The term signal in this case includes both a single pulse as well as a signal sequence.

In a second step 110, the particular driving direction, i.e., the driving direction of motor vehicle 4, is determined. This may take place, for example, with the aid of navigation system 6.

In a third step 120, the driving direction of the other motor vehicle 3 is ascertained. This takes place based on signal 10. The signal strength and/or the transit time of signal 10 may be used for such purpose. Encodings or time stamps of signal 10 may also be used to establish the driving direction of the other motor vehicle 3. This step may be carried out for multiple, other motor vehicles.

In a subsequent step 130, the various driving directions are compared with one another. The plausibility for wrong-way driving of a motor vehicle is then checked as a function of the ascertained driving directions. If all driving directions coincide, then no wrong-way driving exists. If the driving direction of motor vehicle 4 differs from one or multiple driving directions of the other motor vehicles 3, which is depicted in FIG. 1, the plausibility for wrong-way driving of motor vehicle 4 is then checked. If, however, the driving direction of motor vehicle 4 and other motor vehicles 3 coincide, and the driving direction of one other individual motor vehicle 3 is opposite the driving direction of motor vehicle 4, then the plausibility for wrong-way driving of this one other motor vehicle 3 is checked.

In a further step 140, the plausibility for wrong-way driving may be further checked, for example, using data from navigation system 6 or from a navigation module or navigation program of a cellular telephone. Based on these data, it may be determined whether motor vehicle 4 is situated on a directional roadway 2 or whether motor vehicle 4 is moving in a permitted driving direction. The individual steps of checking for plausibility may be viewed linearly one after the other, or parallel to one another. Thus, each step of checking for plausibility may be assigned a certain probability or a percentage, wherein wrong-way driving may be detected or determined when a certain percentage of steps of checking for plausibility has been exceeded. Thus, with each step of checking for plausibility, the probability of wrong-way driving increases.

If a wrong-way driver or wrong-way driving is detected, the respective wrong-way driver, other road users or authorities may receive a warning. This warning may be transmitted by systems of the motor vehicles such as, for example, the navigation system or audio system, a cellular telephone or by radio.

What is claimed is:

1. A method for checking for a plausibility of wrong-way driving of a motor vehicle having a wireless receiving unit on a directional roadway, the method comprising:
receiving at least one signal of a wireless receiving unit of one other motor vehicle;
ascertaining a driving direction of the other motor vehicle based on the at least one signal; and
checking for the plausibility of wrong-way driving of the motor vehicle or of the other motor vehicle based on the driving direction of the motor vehicle and the driving direction of the other motor vehicle.

2. The method of claim 1, wherein the driving direction of the other motor vehicle is ascertained based on a signal strength of the signal.

3. The method of claim 1, wherein the driving direction of the other motor vehicle is ascertained based on a transit time of the signal.

4. The method of claim 1, wherein wrong-way driving of the motor vehicle is detected when the driving direction of the motor vehicle is opposite the driving directions of at least two other motor vehicles.

5. The method of claim 1, wherein the motor vehicle, in order to check for a plausibility of wrong-way driving of the motor vehicle, has ascertained at least two signals having an opposite driving direction.

6. The method of claim 1, wherein the other motor vehicle, in order to check for a plausibility of wrong-way driving of the motor vehicle, has ascertained at least one signal having an identical driving direction and one signal having an opposite driving direction.

7. The method of claim 1, wherein a plausibility for the driving direction of the motor vehicle is checked using a positioning sensor and/or navigation system of the motor vehicle, and/or wherein plausibility for the driving direction of the other motor vehicle is checked using a positioning sensor and/or navigation system of the other motor vehicle.

8. The method of claim 1, wherein the motor vehicle includes a wireless transmitting unit and the other motor vehicle includes a wireless receiving unit, and wherein the signals are sent bi-directionally.

9. The method of claim 1, wherein a warning is generated during a check for plausibility and/or detection.

10. A control device and detection device for checking for a plausibility of wrong-way driving of a motor vehicle having a wireless receiving unit on a directional roadway, comprising:
a receiving arrangement to receive at least one signal of a wireless transmitting unit of one other motor vehicle;
an ascertaining arrangement to ascertain a driving direction of the other motor vehicle, based on the at least one signal; and
a checking arrangement to check for the plausibility of wrong-way driving of the motor vehicle or of the other motor vehicle, based on the driving direction of the motor vehicle and on the driving direction of the other motor vehicle.
